(19) United States
(12) Patent Application Publication
(10) Pub. No.: US 2017/0119187 A1
(43) Pub. Date: May 4, 2017

(54) NapClone

(71) Applicant: Adrienne M. Beaudoin, College Park, MD (US)

(72) Inventor: Adrienne M. Beaudoin, College Park, MD (US)

(21) Appl. No.: 14/931,821

(22) Filed: Nov. 3, 2015

(51) Int. Cl. A47G 23/03; B32B 3/26

(52) U.S. Cl. CPC A47G 23/0303; B32B 3/26; B32B 2260/04; B32B 2307/726; B32B 2307/7265; B32B 2307/744; B32B 2571/00; B32B 2475/00

(57) ABSTRACT

An absorbent napkin comprising high absorbent material with infused table salt is disclosed. The infused table salt prevents drinks from adhering to the napkin. It absorbs the condensed water around the beverage container, and has a high absorbance that prevents condensation or other liquid from passing through the napkin and onto a table top or other supporting surface. This absorbent napkin also does not stick to the bottom of a beverage container or cling with the beverage container when the beverage container is lifted off of the napkin. This is utilized to serve the drinks, to absorb the condensed water or other liquid, and, thereby, prevent the napkin from clinging with the beverage container.

### CROSS REFERENCE TO RELATED APPLICATION

Not Applicable

### FEDERALLY SPONSORED RESEARCH AND DEVELOPMENT Not Applicable

### MICROFICHE APPENDIX

Not Applicable

### BACKGROUND OF THE INVENTION

(1) Field of Invention

The present invention relates to absorbent devices, and, in particular, to an absorbent napkin infused with table salt to prevent drinks from clinging to napkins.

(2) Background of Invention

A variety of glasses are often used at dinner parties, restaurants, or meals at home to serve drinks. When filled with cold liquids, such as water, wine, or other beverages, condensation accumulates on the outside of the glass, which eventually falls onto the user's hand. It becomes quite bothersome to the individual holding the glass to continually have condensation drip down.

Various absorbent devices exist. The function of these devices is to soak up excess liquid. Oftentimes, these devices are wrapped about a wine bottle to catch liquid that might otherwise drip when the wine is poured. Additionally, other absorbent devices may be placed under or around the base of a glass and, thereafter, absorb any condensation dripped from a glass down the stem.

A problem that arises with these absorbers is that they are either used with glasses or bottles to prevent dripping from them during pouring, or they are used on the base of the glass or bottle. Having an absorbing material on the base does not prevent condensation from dripping and clinging with the glasses or the user's hand. Furthermore, these absorbing devices may not provide the aesthetic qualities one would prefer to be associated with wineglasses or goblets.

U.S. patent application Ser. No. 14/194,920, issued Sep. 18, 2014 to Steve Brasel, discloses a multi-layered napkin that is comprised of an upper layer that makes contact with the bottom surface of a beverage. The upper layer is porous, such that the condensation from the beverage is able to pass through the upper layer into subsequent absorbent layers.

U.S. Pat. No. 6,228,459, issued May 8, 2001 to D. Bujalski, describes an absorbent wine bottle wrap that may absorb any liquid that drips from the bottle. The wrap is placed around the neck of a bottle while one corner portion wraps about the bottle and inserts within a slit defined in the wrap. The corner portion is pulled snug through the slit, securing the wrap about the bottle.

U.S. Pat. No. 4,958,798, issued Sep. 25, 1990 to Julie W. Parker, provides a Cocktail napkin. This napkin is adapted to serve as a coaster for a cocktail glass. It is comprised of a body of absorbent paper with an upper porous surface of water repellant material that, when the base of a cocktail glass is rested thereon, conducts condensed moisture from the base into the absorbent body and prevents the formation of a layer or film of water between the base and the napkin. The layer thereby prevents the napkin from sticking to said base.

Additional patents showing absorbent devices include U.S. Pat. No. 3,195,847, issued Jul. 20, 1965 to E. Squires (absorbable support), U.S. Pat. No. 3,797,796, issued Mar. 19, 1974 to H. Lansdowne (coaster), U.S. Pat. No. 3,914,797, issued Oct. 28, 1975 to B. Stembridge (invalid bib), U.S. Pat. No. 4,340,146, issued Jul. 20, 1982 to J. Stratton (disposable coaster), U.S. Pat. No. 4,867,214, issued Sep. 19, 1989 to D. Fuller (dual function jacket for bottle-shaped containers), and U.S. Pat. No. 4,953,823, issued Sep. 4, 1990 to W. Sheaffer et al. (coaster and wipe).

There is a need for an absorbent device that absorbs the condensation around the glass/bottle, does not cling to the glass/bottles, and is aesthetically pleasing to an individual.

None of the above inventions and patents, taken either singly or in combination, are seen to describe the instant invention, as claimed. Thus, a salt-infused napkin solving the aforementioned problems is desired.

### BRIEF SUMMARY OF THE INVENTION

In view of the foregoing disadvantages inherent in the known types of absorbent devices now present in the prior art, the present invention provides an absorbent napkin, wherein the same provides high absorbance and prevents the napkin from clinging by using process of various components employed in the procedure. As such, the general purpose of the present invention, which will be described subsequently in greater detail, is to provide a new and improved absorbent napkin that has all of the advantages of the prior art, and none of the disadvantages.

Accordingly, it is a primary objective of the present invention to provide an absorbent napkin that is comprised of infused table salt into a dry napkin to prevent drinks from adhering to the napkin.

In another aspect, the present invention provides an absorbent napkin that absorbs the condensed water around the beverage container.

It is yet another objective of the present invention to provide a napkin that has high absorbance and prevents condensation or other liquid from passing through the napkin and onto a tabletop or other supporting surface.

Another objective of the present invention is to provide a napkin that does not stick to the bottom of a beverage container when the beverage container is lifted off of the napkin.

It is yet another objective of the present invention to provide a new and improved absorbent napkin that may be easily and efficiently manufactured and marketed.

It is an objective of the present invention to provide a new and improved absorbent napkin that is of a durable and reliable construction.

Other aspects of the present invention will become apparent, from time to time, throughout the specification, as hereinafter related.

In this respect, before explaining at least one embodiment of the invention in detail, it is to be understood that the invention is not limited in its application to the details of construction and to the arrangements of the components set forth in the following description or illustrated in the drawings. The invention is capable of other embodiments, and of being practiced and carried out in various ways. Also, it is to be understood that the phraseology and terminology employed herein are for the purpose of description, and should not be regarded as limiting.

These, together with other objectives of the invention and the various features of novelty that characterize the invention, are pointed out with particularity in the disclosure. For a better understanding of the invention, its operating advantages, and the specific objectives attained by its uses, reference should be had to the accompanying drawings and descriptive matter, in which there are illustrated preferred embodiments of the invention.

### BRIEF DESCRIPTION OF THE DRAWINGS

To further clarify various aspects of some example embodiments of the present invention, a more particular description of the invention will be rendered by reference to specific embodiments thereof, which are illustrated in the appended drawing. It is appreciated that the drawing depicts only illustrated embodiments of the invention, and is, therefore, not to be considered limiting of its scope. The invention will be described and explained with additional specificity and detail through the use of the accompanying drawing, in which:

FIG.1 is a perspective view of the absorbent napkin infused with table salt.

### DETAILED DESCRIPTION OF THE INVENTION

Various aspects of the illustrative embodiments will be described using the terms commonly employed by those skilled in the art to convey the substance of their work to others skilled in the art. However, it will be apparent to those skilled in the art that the present invention may be practiced with only some of the described aspects. For purposes of explanation, specific numbers, materials, and configurations are set forth in order to provide a thorough understanding of the illustrative embodiments. However, it will be apparent to one skilled in the art that the present invention may be practiced without the specific details. In other instances, well-known features are omitted or simplified in order to not obscure the illustrative embodiments.

In some preferred embodiments, the present invention provides an absorbent napkin that is adapted to prevent the adhesion of the napkin to the bottom of a beverage container when the condensation from the container drips onto the napkin. The napkin is comprised of several layers stacked on top of one another so as to form a single unitary structure, which is infused with the table salt.

The removal of condensation from the top layer of the absorbent napkin prevents the bottom of a beverage container from adhering to the napkin. The subsequent layers are positioned to improve the absorbance, and are impermeable to liquid. The underside surface of the base layer is comprised of a high-friction material that is configured to maintain the napkin on a tabletop when a beverage container is removed from the napkin. The high-friction material is disposed thereon such that it does not lift off of the surface of the table when a beverage container resting on the napkin is lifted.

In one embodiment, the absorbent napkin prevents condensation or other liquids from passing through the napkin and onto a table top or other supporting surface. In another embodiment, the absorbent napkin does not stick to the bottom of a beverage container when the beverage container is lifted off of the napkin.

Reference is made herein to the attached drawing. Like reference numerals are used throughout the drawings to depict like or similar elements of the absorbent napkin. For the purposes of presenting a brief and clear description of the present invention, the preferred embodiment will be discussed as used for protecting a table top or other surface from water damage while preventing the present invention from sticking onto the bottom of a beverage container or clinging with the beverage container. The figures are intended for representative purposes only, and should not be considered to be limiting in any respect.

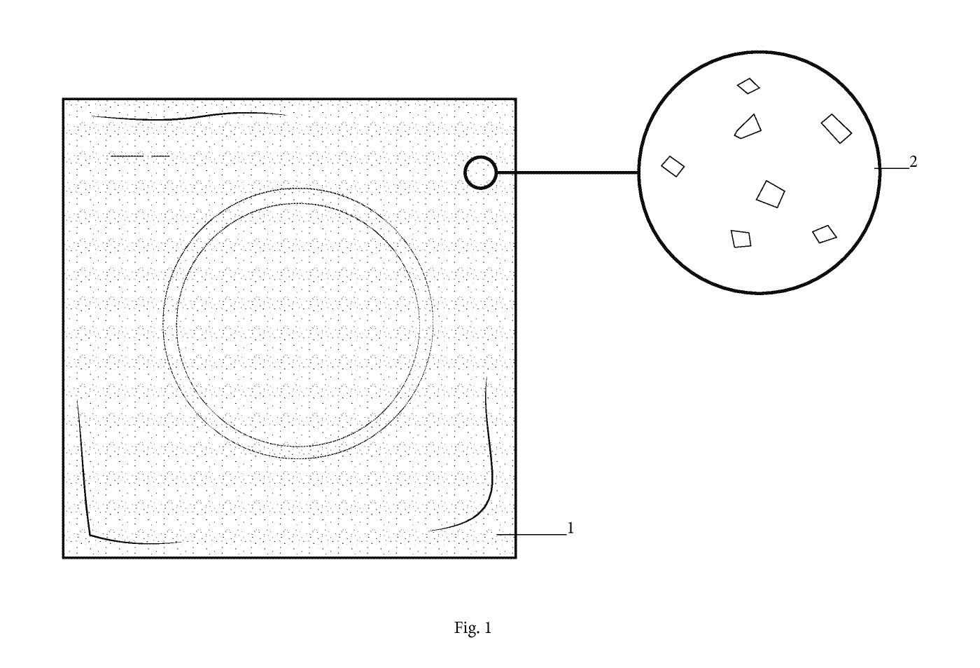

Referring now to FIG. 1, there is shown a view of the absorbent napkins of the present invention designated generally by the reference character. The absorbent napkin 1, infused with a layer of table salt 2, is adapted to absorb condensation that forms on the exterior of the beverage containers so as to prevent the liquid from contacting the table top.

The uppermost layer of the absorbent napkin is infused with the table salt, and is composed of a porous material that facilitates the passage of condensation from the surface of the napkin to the subsequent absorbent layers. In this way, the upper layer is able to remain relatively dry, such that the napkin does not adhere to the beverage container when the beverage container is removed from the napkin.

Thus, the removal of liquid from the uppermost layer of the napkin prevents the adhesion of the napkin to the bottom of the beverage container. Thus, the napkin does not cling with the beverage container. Furthermore, the base layer is comprised of a high-friction material on its underside surface that also serves to maintain the napkin in place on a table top when a beverage container is lifted off of the absorbent napkin.

As may now be appreciated from the above description and reference to the accompanying drawings, the present invention provides an absorbent napkin that may be utilized to serve drinks, absorb the condensed water or other liquid, and, thereby, prevent the napkin from clinging with the beverage container.

It is to be understood that the above description is intended to be illustrative, and not restrictive. For example, the above-discussed embodiments may be used in combination with each other. Many other embodiments will be apparent to those of skill in the art upon reviewing the above description.

With respect to the above description then, it is to be realized that the optimum dimensional relationships for the parts of the invention, to include variations in size, materials, shape, form, function and manner of operation, assembly, and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Furthermore, since numerous modifications and changes will readily occur to those skilled in the art, it is not desired to limit the invention to the exact construction and operation shown and described. Accordingly, all suitable modifications and equivalents may be resorted to, falling within the scope of the invention.

I claim:

1. A unitary absorbent structure comprising a plurality of layers.

2. The unitary absorbent structure according to claim 1, wherein the unitary absorbent structure has a square shape.

3. The unitary absorbent structure according to claim 1, wherein the unitary absorbent structure is placed between a bottom surface of a beverage container and a top of a table.

4. The unitary absorbent structure according to claim 1, wherein the plurality of layers are stacked on top of each other.

5. The unitary absorbent structure according to claim 1, wherein an uppermost layer of the unitary absorbent structure is infused with table salt.

6. The unitary absorbent structure according to claim 1, wherein the uppermost layer is composed of a porous material.

7. The unitary absorbent structure according to claim 6, wherein the porous material facilitates passage of condensates present at the bottom surface of the beverage container.

8. The unitary absorbent structure according to claim 6, wherein all the subsequent layers after the uppermost layer are impermeable to a liquid.

9. The unitary absorbent structure according to claim 6, wherein a lowermost layer of the unitary absorbent structure comprises a high-friction material keeping the unitary absorbent structure on the top of the table.

10. The unitary absorbent structure according to claim 1, wherein the unitary absorbent structure is a napkin.
